(19) United States
(12) Patent Application Publication
(10) Pub. No.: US 2007/0056314 A1
(43) Pub. Date: Mar. 15, 2007

(54) LIQUID DISPENSER

(75) Inventors: Mohammed Mali, Calgary (CA); Hussein Desouki, Calgary (CA)

Correspondence Address: LAW OFFICE OF MARC D. MACHTINGER, LTD., 750 W. LAKE COOK ROAD, SUITE 350, BUFFALO GROVE, IL, 60089, US

(73) Assignee: INNOVATIVE PRODUCTS FOR LIFE INC., Calgary (CA)

(21) Appl. No.: 11/162,436

(22) Filed: Sep. 9, 2005

(51) Int. Cl. B67D 5/62; F25D 5/00; F24J 1/00

(52) U.S. Cl. 62/389; 62/4; 222/146.1; 126/263.01

(57) ABSTRACT

A liquid dispenser has a base, a reservoir removably attached to the base, a recess in the base for receiving a temperature-maintaining insert, and an outlet for dispensing a liquid stored in the reservoir. The base may also have a bowl for receiving the dispensed liquid, where the dispenser is intended to be used by a pet, such as a dog or a cat.

### BACKGROUND OF THE INVENTION

Various liquid dispensers for pets are known. These generally incorporate a base with a reservoir attached to the base, such as a water bottle. The base typically has a basin or bowl where water flowing from the reservoir pools. Various methods of controlling flow also exist, but in the simplest form, some dispensers have an outlet communicating between the reservoir and the basin, and water fills up the basin until it rises above the level of the outlet, at which point, flow ceases until the level is reduced, which usually happens whenever a pet drinks from the basin.

Also known are liquid dispensers that provide for some form of keeping the water cool or warm, depending on the temperature outdoors. Where heating is required, typically a heat source powered by electricity is provided, whether in the form of a heating coil or a lamp. For cooling, solutions range from freezeable water bowls to fountains that continually re-circulate and filter the water. It is also known to insert a cooling member, such as an ice pack, into a water bottle having a cavity adapted for receiving the ice pack, as taught in U.S. Pat. No. 5,738,038. However, as the water level in the bottle goes down, the surface area of the insert in contact with the water is also reduced, thereby limiting the cooling effect of the insert and exposing more of the insert to the ambient temperature.

### SUMMARY OF THE INVENTION

There is therefore provided a liquid dispenser that can be used for humans or animals, that can keep the liquid at a desired temperature for longer periods of time, whether hot or cold, and that is easily portable and does not require electric power.

The liquid dispenser comprises a base, a reservoir for storing a liquid having a temperature, the reservoir removably attached to the base, a recess in the base for receiving a temperature-maintaining insert for maintaining the temperature of the liquid, and an outlet in the base for dispensing the liquid.

In another embodiment, a liquid dispenser comprises a base, a reservoir for storing a liquid having a temperature, the reservoir having a top and a bottom, the top being removably attached to the base, a side accessible recess in the reservoir nearer to the top than the bottom for receiving a temperature-maintaining insert for maintaining the temperature of the liquid, and an outlet in the base for dispensing the liquid.

In another embodiment of the invention, an apparatus comprises a base having a bottom, sides, and a top, the top having an opening for receiving a reservoir for storing a liquid having a temperature. The base also has a recess for receiving a temperature-maintaining insert for maintaining the temperature of the liquid, and an outlet for dispensing the liquid from the reservoir. The apparatus may further comprise a basin for receiving liquid dispensed from the reservoir.

These and other aspects of the invention are set out in the claims, which are incorporated here by reference.

### BRIEF DESCRIPTION OF THE FIGURES

Preferred embodiments of the invention will now be described with reference to the figures, in which like reference characters denote like elements, by way of example, and in which:

FIG. 1 is a perspective view of a liquid dispenser;

FIG. 2 is a perspective view of a base for a liquid dispenser;

FIG. 3 is a perspective view of the liquid dispenser of FIG. 1, showings its components separated;

FIG. 4 is a perspective view of another embodiment of a liquid dispenser;

FIG. 5 is a perspective view of another embodiment of a base for a liquid dispenser;

FIG. 6 is a perspective view of the liquid dispenser of FIG. 4, showing its components separated;

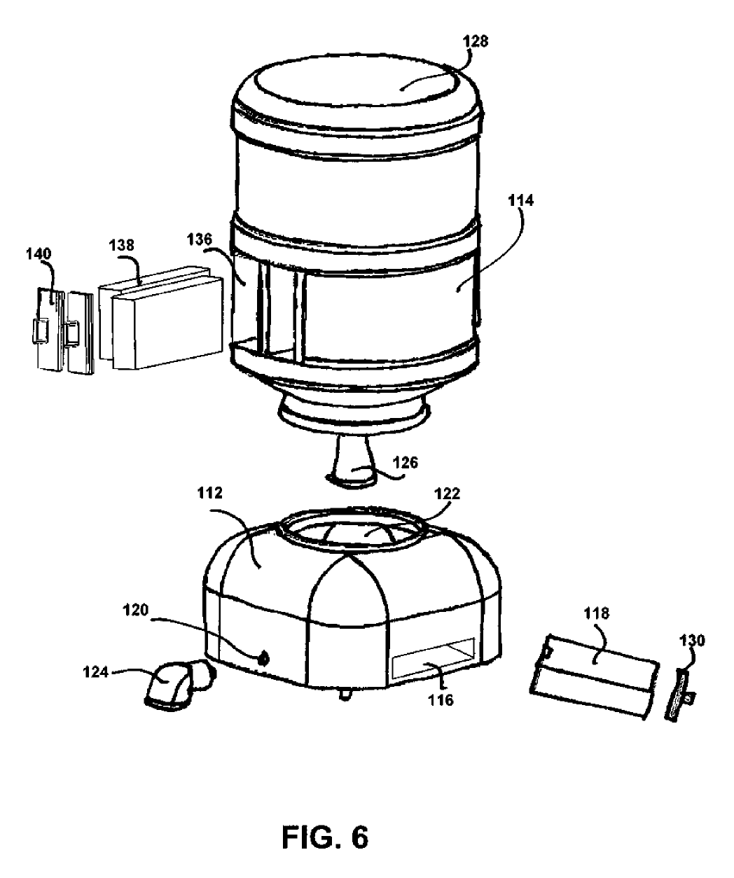

FIG. 7 is a perspective view of one embodiment of a reservoir; and

FIG. 8 is a perspective view of another embodiment of a reservoir.

### DETAILED DESCRIPTION OF THE PREFERRED EMBODIMENTS

In the claims, the word “comprising” is used in its inclusive sense and does not exclude other elements being present. The indefinite article “a” before a claim feature does not exclude more than one of the feature being present.

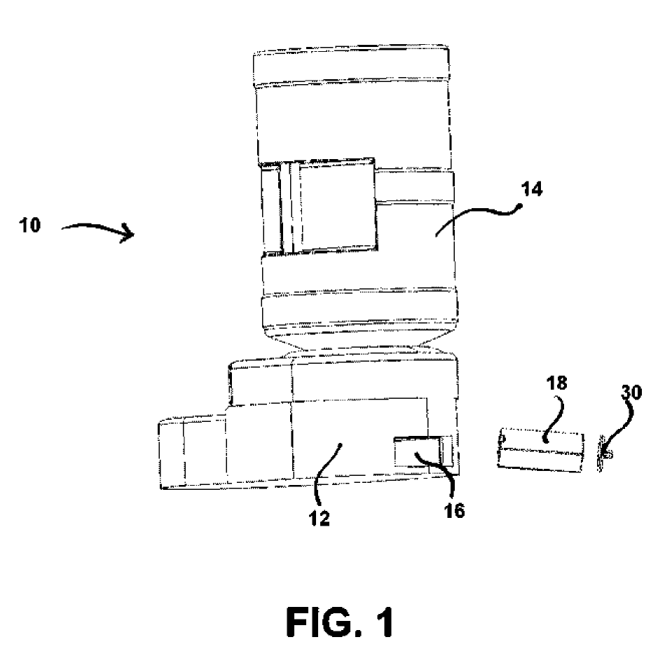

A liquid dispenser 10 according to the invention is shown in FIG. 1. The liquid dispenser 10 has a base 12, a reservoir 14 for storing a liquid having a temperature, and recess 16 in the base 12 for receiving a temperature-maintaining insert 18.

The temperature-maintaining insert 18 may be a refreezeable or reheatable pack available from a variety of suppliers, such as Cryopak Industries, Nulife Medical, and Roshgo Corporation. Such temperature-maintaining inserts typically contain some form of gel, but it should be understood that any form of hot or cold pack that fits within the recess 16 may be used, and the hot or cold pack may contain any material suitable for cooling or heating. The temperature-maintaining insert 18 may have a rigid external shell, or may be flexible.

Likewise, the temperature-maintaining insert may be an instant hot or cold pack, such as those sold under the names Kwik-Heat®, Kwik-Cold®, Jack Frost™ and Re-Heater™. These types of hot and cold packs typically involve some form of chemical reaction that makes the pack hot or cold relatively instantaneously, and are typically activated by squeezing the hot or cold pack. Some, like the Re-Heater™, are re-usable. Such instant hot or cold packs will typically last between half an hour and an hour before losing their effectiveness. For most applications, a reusable hot or cold pack is preferred because this type of pack maintains its effectiveness for a longer period of time. One skilled in the art will use the temperature-maintaining insert most suitable for the conditions under which the liquid dispenser 10 may be used.

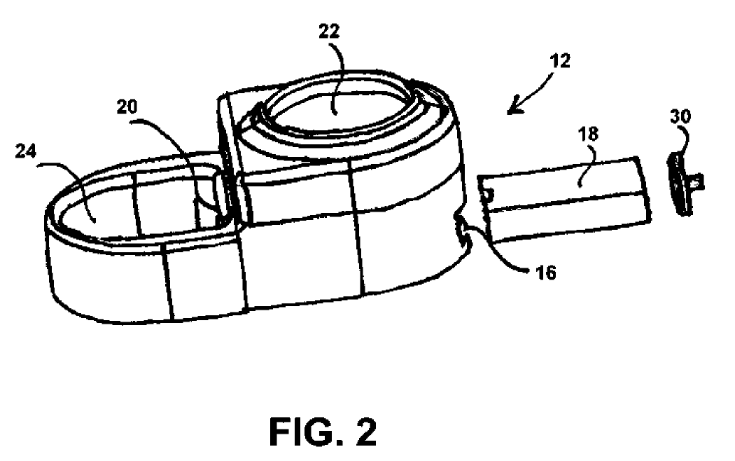

As shown in FIG. 2, a base 12 for a liquid dispenser has a recess 16 for receiving a temperature-maintaining insert 18, an outlet 20 for dispensing liquid from a reservoir, an opening 22 for receiving a reservoir containing a liquid, and a basin 24 where liquid dispensed from the outlet 20 may pool.

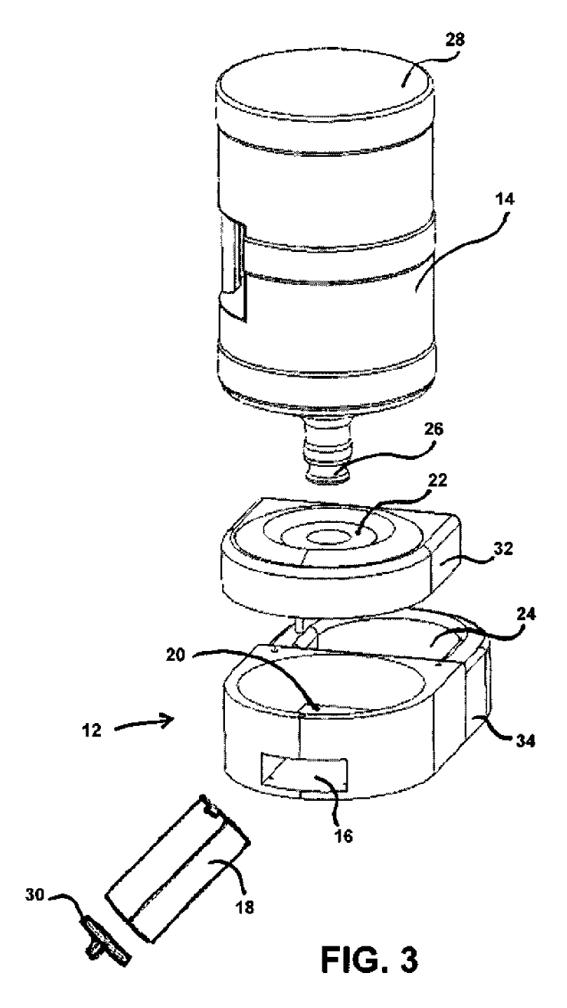

As shown in FIG. 3, the reservoir 14 has a top 26 and a bottom 28 The top 26 is received by the opening 22 in the base 12. The base 12 may consist of two parts, an upper base portion 32 and a lower base portion 34, or the base 12 may be of unitary construction, as in FIG. 2. The opening 22 is shaped to receive the top 26 of a standard water bottle for a liquid dispenser, which typically ranges a storage capacity of 2 gallons to 5 gallons (approximately 8 litres to 20 litres). However, it should be understood that the opening 22 could also be threaded to be connected to a bottle having a threaded top, such as 750 mL, 1 L, or 2 L water bottle, or the opening 22 could be otherwise shaped in a manner suitable for receiving a particular type of reservoir.

When the liquid dispenser 10 is intended to be used for animals, a basin 24 may be provided, as shown in FIGS. 1, 2 and 3. In such instances, an outlet 20 in the base connects the reservoir 14 to the basin 24, permitting flow of liquid from the reservoir 14 to the basin 24. It should be understood that any type of outlet that controls the flow of liquid from the reservoir 14 would be suitable. In a simple embodiment, the top of the reservoir may be positioned so that when the basin is filled with water, the top of the reservoir is submerged, thus preventing further liquid from flowing from the reservoir. When an animal drinks from the basin and the water level is reduced, further water is then released from the reservoir until the water level basin again reaches a point where no further water flows from the reservoir.

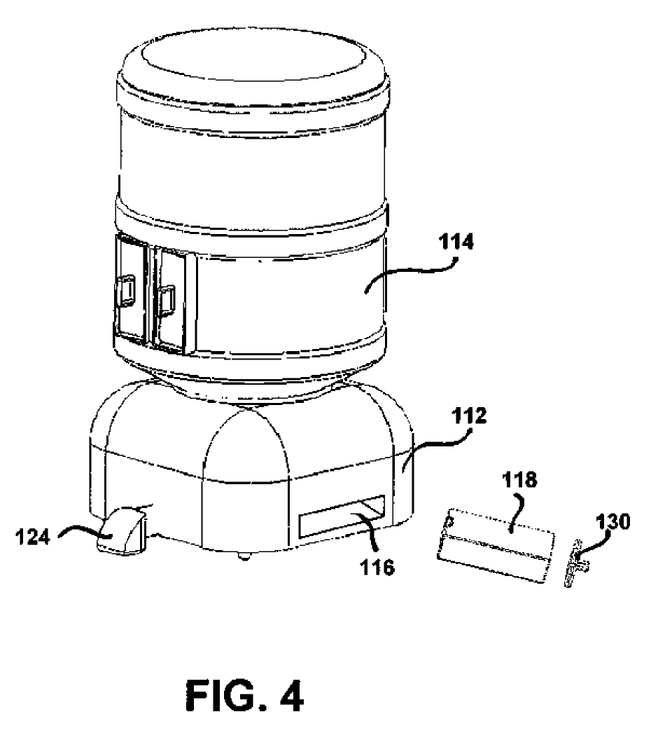

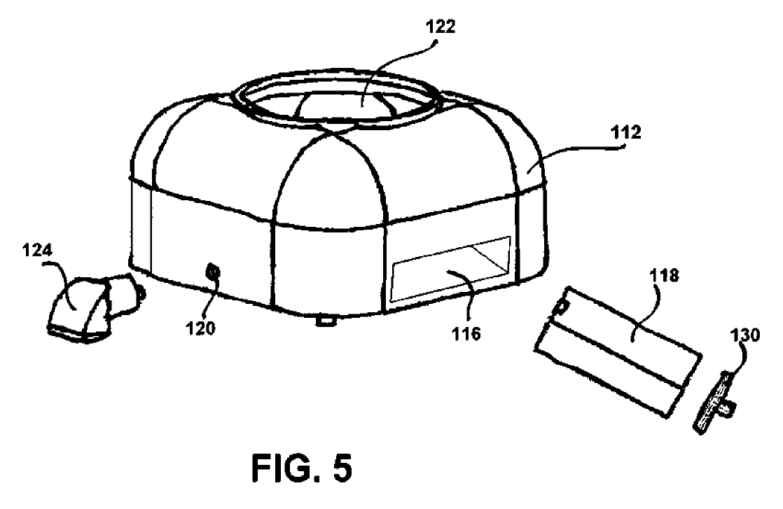

When the liquid dispenser 110 is used, the base 112 may have a push tap 124, a faucet, a spigot or other sort of valve connected to the outlet 120 to release liquid on demand when operated by a person getting a drink, as shown in FIGS. 4 and 5. It should be understood that the recess 116 could be positioned on any side of the base 112, as long as the recess 116 does not interfere with the outlet 120.

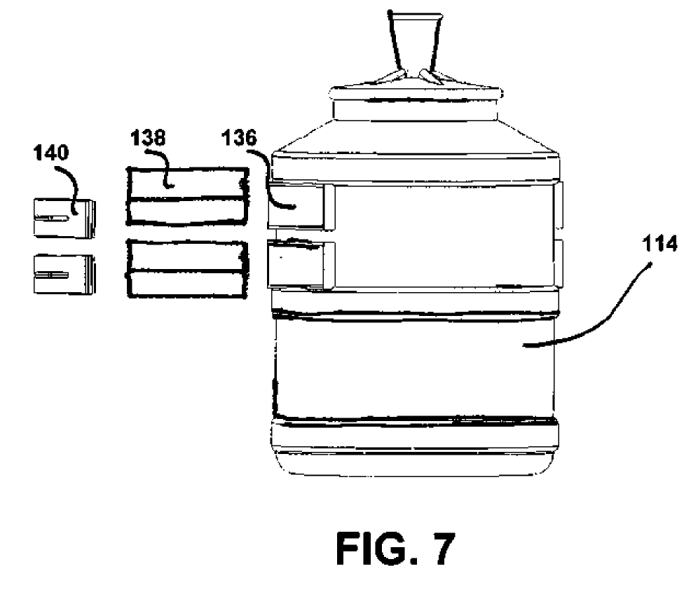

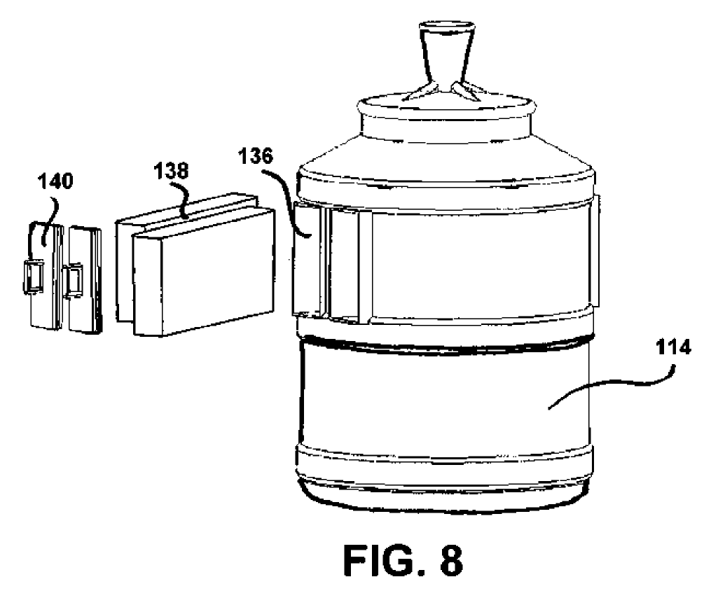

The reservoir 114 may also have a side accessible recess 136. The side accessible recess 135 is preferably located nearer to the top 126 than the bottom 128 of the reservoir 114. There may be more than one side accessible recess 136. The side accessible recess 136 may be configured lengthwise or widthwise, as seen in FIGS. 7 and 8. The side accessible recess 136 as shown is rectangular, but could be any shape suitable for receiving a temperature-maintaining insert. The side accessible recess could be a transversely extending recess extending more in the lateral direction than in the up and down direction. Since cold travels downward, the side accessible recess 136 in a preferred embodiment does not have to keep as much of the liquid cool, being positioned nearer to the top 126, which is below the bottom 128 when the reservoir 114 is inverted for use. Likewise, for heating applications, the side accessible recess 136 has the advantage of being surrounded by liquid for a longer period of time, so that heat is not lost as quickly as would be the case if a heated temperature-maintaining insert were located in the bottom 128 of the reservoir 114, which is the highest point of the liquid dispenser 110 when the reservoir 114 is inverted for use.

The recess 16 or 116 or the side accessible recess 136 may have a cover 30 or 130 or 140 or a drawer (not shown) or a clipping mechanism (not shown) or some other device for holding the temperature-maintaining insert 18 or 118 or 138 securely in the recess 16 or 116 or the side accessible recess 136, if this is desired. Likewise, the cover 30 or 130 or 140 or other device may be insulated to provide a further temperature-maintaining function by keeping the temperature-maintaining insert 18 or 118 or 138 separated from the ambient temperature outside of the base 12 or 112 or the reservoir 114.

In a preferred embodiment, the base 12 or 112 may be used with any suitable reservoir and does not require a reservoir specially adapted to fit the base 12 or 112. When the liquid dispenser 110 is used, the reservoir 114 may be used to store any liquid consumed by people, such as iced tea or juice where a cold temperature-maintaining insert is used, or coffee or hot chocolate where a hot temperature-maintaining insert is used. Likewise, a hot temperature-maintaining insert may be used with the liquid dispenser 10 where water for pets needs to be kept from freezing, or in the liquid dispenser 110 where a hot beverage needs to be kept from cooling down too rapidly, such as in cold weather conditions outdoors. The reservoir may have an insulating jacket to aid in maintaining the temperature of the liquid. The base 12 or 112 and the liquid dispenser 10 or 110 are useful where electric power supplies are not available and provide an easily portable solution to maintaining the temperature of a liquid for an extended period of time.

Immaterial modifications may be made to the embodiments of the invention described here without departing from the invention.

What is claimed is:

1. A liquid dispenser, comprising:
a base;
a reservoir for storing a liquid having a temperature, the reservoir removably attached to the base;
a recess in the base for receiving a temperature-maintaining insert for maintaining the temperature of the liquid; and
an outlet in the base for dispensing the liquid from the reservoir.

2. The liquid dispenser of claim 1 in which the temperature-maintaining insert is a refreezeable cold pack or a reheatable hot pack.

3. The liquid dispenser of claim 1 in which the temperature-maintaining insert is an instant cold or instant hot pack that produces a temperature as a result of a chemical reaction within the instant cold or instant hot pack.

4. The liquid dispenser of claim 1 in which the outlet communicates with one of a tap, faucet, valve, or spigot.

5. The liquid dispenser of claim 1 in which the outlet communicates with a basin in the base for receiving dispensed liquid.

6. The liquid dispenser of claim 5 in which the base comprises an upper base portion removably attached to a lower base portion, the upper base portion being formed to receive the top of the reservoir.

7. The liquid dispenser of claim 6 in which the recess is located in the lower base portion.

8. The liquid dispenser of claim 6 in which the basin is located in the lower base portion.

9. The liquid dispenser of claim 1 in which the reservoir further comprises a top and a bottom, the top being removably attached to the base; and
a side accessible recess for receiving a temperature-maintaining insert for maintaining the temperature of the liquid.

10. The liquid dispenser of claim 9 in which the side accessible recess is nearer to the top of the reservoir than the bottom.

11. The liquid dispenser of claim 9 in which the side accessible recess extends transversely in the reservoir more in a lateral direction than in an up and down direction.

12. A liquid dispenser, comprising:
a base;
a reservoir for storing a liquid, the reservoir having a top and a bottom, the top being removably attached to the base;
a side accessible recess in the reservoir for receiving a temperature-maintaining insert for maintaining the temperature of the liquid; and
an outlet in the base for dispensing the liquid from the reservoir.

13. The liquid dispenser of claim 12 in which the side accessible recess is nearer to the top of the reservoir than the bottom.

14. The liquid dispenser of claim 12 in which the side accessible recess extends transversely in the reservoir more in a lateral direction than in an up and down direction.

15. The liquid dispenser of claim 12 in which the temperature-maintaining insert is a refreezeable cold pack or a reheatable hot pack.

16. The liquid dispenser of claim 12 in which the temperature-maintaining insert is an instant cold or instant hot pack that produces a temperature as a result of a chemical reaction within the instant cold or instant hot pack.

17. The liquid dispenser of claim 12 in which the base further comprises a recess for receiving a temperature-maintaining insert.

18. The liquid dispenser of claim 12 in which the outlet communicates with one of a tap, faucet, valve, or spigot.

19. The liquid dispenser of claim 12 in which the outlet communicates with a basin in the base for receiving dispensed liquid.

20. The liquid dispenser of claim 19 in which the base comprises an upper base portion removably attached to a lower base portion, the upper base portion being formed to receive the top of the reservoir.

21. The liquid dispenser of claim 20 in which the lower base portion further comprises a recess for receiving a temperature-maintaining insert.

22. The liquid dispenser of claim 20 in which the basin is located in the lower base portion.

23. An apparatus, comprising:
a base having a bottom, sides, and a top;
an opening in the top for receiving a reservoir for storing a liquid;
a recess for receiving a temperature-maintaining insert; and
an outlet for dispensing the liquid from the reservoir.

24. The apparatus of claim 23 further comprising a basin for receiving the dispensed liquid.

25. An apparatus, comprising:
a reservoir for storing a liquid, the reservoir having a bottom and a top, the top shaped for being received by a base of a liquid dispenser; and
a side accessible recess for receiving a temperature-maintaining insert for maintaining a temperature of a liquid stored in the reservoir.

26. The apparatus of claim 25 in which the side accessible recess is nearer to the top of the reservoir than the bottom.

27. The apparatus of claim 25 in which the side accessible recess extends transversely in the reservoir more in a lateral direction than in an up and down direction.
